(19) United States
(12) Patent Application Publication
(10) Pub. No.: US 2010/0064633 A1
(43) Pub. Date: Mar. 18, 2010

(54) SHORT DEPTH CARTON FEED DRIVE

(75) Inventors: Robert M. Kalany, Florence, KY (US); Paul A. Frederick, Harrison, OH (US); Scott J. Ziemer, Burlington, KY (US)

Correspondence Address: WOOD, HERRON & EVANS, LLP, 2700 CAREW TOWER, 441 VINE STREET, CINCINNATI, OH, 45202, US

(73) Assignee: R.A. Jones & Co. Inc., Covington, KY (US)

(21) Appl. No.: 12/536,545

(22) Filed: Aug. 6, 2009

Related U.S. Application Data
(60) Provisional application No. 61/086,875, filed on Aug. 7, 2008.

(51) Int. Cl. B65B 41/02; B31B 3/02; B31B 49/02

(52) U.S. Cl. 53/389.1; 493/52

(57) ABSTRACT

An improved carton feed drive includes feed dog drives for delivering carton blanks to transport lugs of a carton. Components of the feed dog drives are inclined to the vertical, providing ability to handle very short depth cartons by operating feed dogs in an operative run closely adjacent the transport lugs while the feed dog drives are inclined away from the transport lug drives so the respective drives to not interfere in any way to unduly limit the ability to handle short depth cartons. Feed dogs are selectively pivoted on their drives to positions for operative engagement of cartons, and are releasable to retracted positions to avoid carton damage as the dogs move to a return run.

### PRIORITY CLAIM

Applicant claims the benefit of the filing date of Aug. 7, 2008 of U.S. provisional patent application Ser. No. 61/086,875, which is expressly incorporated herein by reference.

### TECHNICAL FIELD

The invention relates to cartoning apparatus and more particularly to apparatus for feeding and opening carton blanks into a carton transport.

### BACKGROUND OF THE INVENTION

It is known to feed flat carton blanks into a transport section of a cartoner comprising leading and trailing transport lugs typically mounted on and carried by chains driven by motors for respectively driving the chains and lugs. Blanks are fed toward a leading lug at an end of the transport and a trailing lug is carried up behind the blank to push it toward the lead lug, thus finally erecting the blank if necessary, as the trailing lug moves into final position. The trailing lug is erected and eventually spaced from the leading lug a distance approximately equal to the length of the so-erected carton from front to the back in the machine direction of travel of the lug transport.

Thus, typically in such systems, the blanks are pushed toward the leading transport lugs by feed dogs pushing the rear edge of the blanks in a feed or machine direction. Decreasing distance between the following feed dog and the leading lug preceding it erects the carton blank to three dimensional form. Thereafter, the trailing transport lugs of the transport swing around an entry end of the transport section to engage and further erect the carton if necessary, by urging it forwardly against the lead lug. Once the trailing lug engages the carton, the feeding dogs drop away from the operating run and the carton and return over a return run to pick up succeeding flat blanks at an entry end of the carton transport path. This drop away occurs preferably just before the rear edge of the erected carton is engaged by any trailing transport lug for any final erection and further transport.

Typically, the leading transport lugs are carried by two chains operating in or on two tracks, while the trailing transport lugs are carried on two separate chains, operating in or on two other tracks. The chain drives are independently adjustable for changing the distance or phase between leading and trailing lugs and enabling the cartoner to handle various size cartons.

The feed dogs for feeding the flat blanks also are typically carried by chains operating in or on their own track.

Such configuration works well for blanks of relatively wide “depth” (measured end-to-end in a direction transverse to the machine direction). For wider cartons, there is sufficient transverse space across the cartoner to accommodate the transport lugs and the feed dogs as well as their respective drive components. When that carton depth across the apparatus becomes small, however, such as in “4 pack” cartons, where the depth may be only a few inches (such as four inches), transverse operating space becomes a problem.

Particularly at the junction of the feeding lug structure and the entry end of the carton erecting and transport structure, it is difficult to find the necessary transverse space across the cartoner for the chain, track and other components of the transport lug drives and the feed dog drive components across such a short carton depth. For short depth cartons, the typical drive components would interfere and thus limit the capacity of the cartoner to handle shorter depth cartons.

Accordingly, it is desired to provide for feeding of small depth cartons into carton erecting and transport cartoners where the conventional transport and feed drives would otherwise be too wide to all fit within the available adjacent space.

Moreover, another concern is the potential continuing contact of the rear edge of the blank by the feed dogs as they begin to drop away when the trailing transport lugs engage the blanks. This feed dog motion must be controlled, such that the dogs do not tear the rear edge of the blank. Accordingly, it is desired to avoid damaging contact of feed dogs with the carton blanks as the feed dogs move toward their return runs.

### SUMMARY OF THE INVENTION

To these ends, a preferred embodiment of the invention contemplates a feed dog apparatus where feed dogs are driven in a machine direction by feeding dog drives which are inclined and disposed at an angle to the vertical plane in which the transport lugs move. The feed dogs have blank engaging tips angled to present themselves at an operative disposition parallel to the leading and trailing lugs of the transport, yet while the respective drives of the feed dog are disposed in a plane which is at an angle to, and not parallel with, the plane of the chain drives for the leading and trailing lugs. Feed dog drive components are angled or spaced away from the transport lug drive components.

In other words, and according to the invention, the respective chains of the drives for the leading and trailing transport lugs are oriented in a generally vertical plane while respective drive components of each blank feed dog on each side of the carton erection and transport section are oriented in respective common planes disposed at angles to the vertical drive plane. One operative run of the feed dog path is disposed adjacent the erection and transport section and the feed dogs are inclined to a feed position residing in a plane parallel to the leading and trailing transport lugs to properly engage and push the flat carton blanks toward the respective leading lugs. Thus, an operative and a return run of each chain of the feed dog drives lies in a common plane, which is inclined from the vertical. In other words, the drive chain of the feed dogs is in a plane inclined to the vertical.

This orientation permits the use of the feed dogs in very short depth carton figurations where the feed dog drives would not be otherwise accommodated in the narrow width available which is filled up by the four chains and tracks of the leading and trailing transport lug drives. The operative run of each feed dog drive chain can be closely disposed to the operative run of the adjacent transport lug drive since the return run and other components of the feed dog drive is angled or spaced further away from the vertical plane of the transport lug drive.

In another aspect of the invention, the feed dogs are pivoted to their respective chains. A cam for each feed dog drive is oriented to erect the dogs for pushing the flat carton blanks. The erecting cam is discontinued spatially and at a time when the trailing transport lug is just approaching or has just engaged the rear edge of the blank to allow the feed dogs to pivot or fall away and avoid interference with the carton being picked up by the carton lugs. This accelerates the disengagement of the feed dogs so they do not push on the cartons in a way to damage them once the trailing transport lug has engaged the carton or during the short time while the feed dogs rotate about their end sprocket or pulley. Otherwise, downward motion of the feed dog as it moves toward its return run might damage the carton.

These and other aspects of the invention will be readily apparent from the following written description and from the drawings, in which:

### BRIEF DESCRIPTION OF THE FIGURES

FIG. 1 is an isometric line drawing of an embodiment of the invention;

FIG. 1A is an enlarged view of the encircled area of FIG. 1;

FIG. 2 is a side elevational view of the invention in FIG. 1;

FIG. 3 is an end view of the invention from the right-hand end of FIGS. 1 and 2;

FIG. 4 is an end view similar to FIG. 3 but showing the apparatus adjusted for a deeper (transverse width) carton;

FIG. 5 is an isometric view of one inclined feed dog and the rear end of an inclined feed dog drive of FIGS. 1-4;

FIGS. 6 and 6A is an isometric view showing components of a portion of the feed dog drive of FIG. 5, also illustrating the transversally adjustable mount for the feed dog drive;

FIG. 7 is a view of the feed dog drive of FIGS. 5-6 but showing the feed dog drive proximate the blank discharge or forward end of the drive;

FIG. 8 illustrates details of a typical dual chain track for carrying leading and trailing carton transport lugs; and

FIG. 9 illustrates a snap-on carton transport lug in a cartoner according to the invention, and in a detailed position.

### DETAILED DESCRIPTION OF A PREFERRED EMBODIMENT

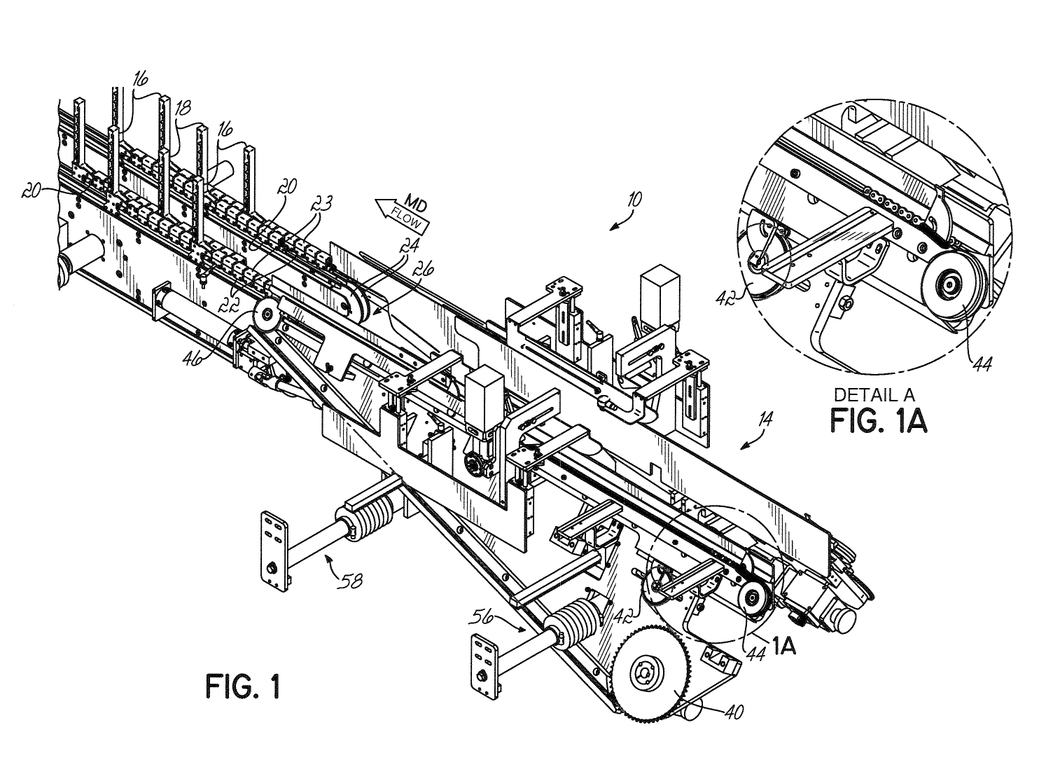

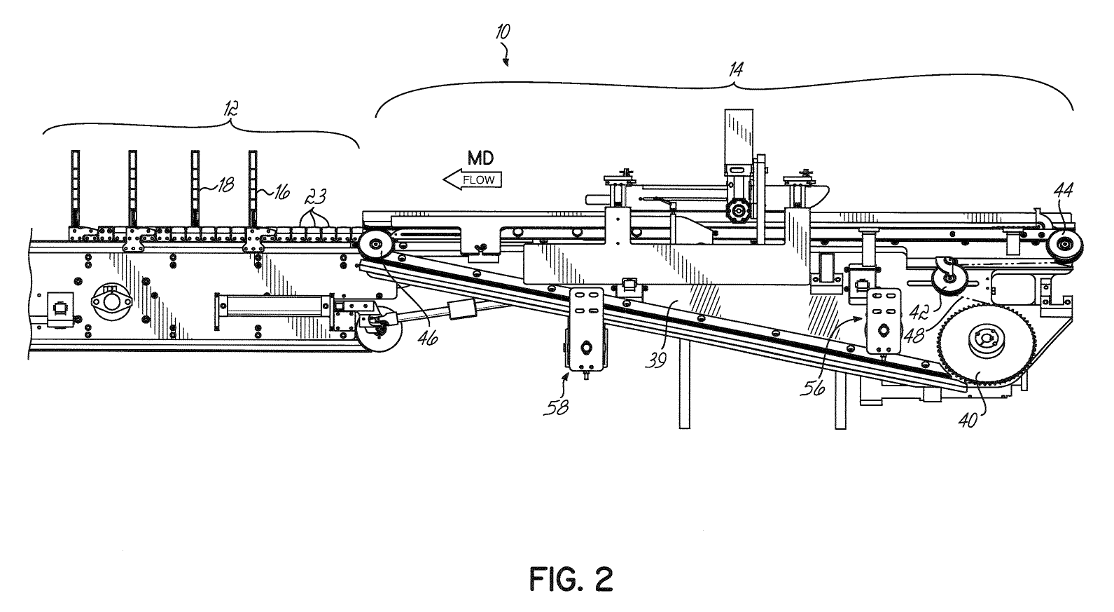

Turning now to the drawings, FIG. 1 illustrates a cartoner 10 according to the invention. Cartoner 10 includes a carton transporting section 12 and a carton blank feeding and erecting section 14 (see FIG. 2).

Section 12 may be a typical transport lug conveyor having leading transport lugs 16 and trailing transport lugs 18 mounted to respective chains 22, 20 drawn around curved tracks as at 24 at a carton blank entry end 26.

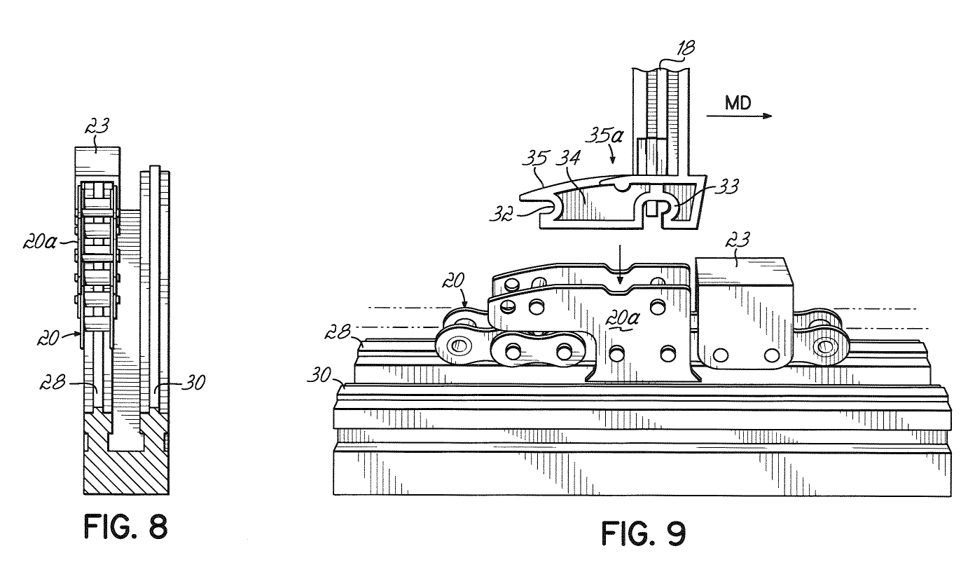

It will be appreciated that each of the leading and trailing lugs 16, 18 are mounted on one of the respective chains 20, 22 (inside chain 20 and outside chain 22 carried on respective tracks 28, 30 (FIG. 8)), a pair of which are disposed on each side of cartoner 10. Thus, the leading and trailing transport lugs 16, 18 are independently driven and are independently adjusted with respect to each other. As is commonly known in prior cartoners generally each chain 20 and each chain 22 are preferably independently driven, the phase of any chain to another being adjusted by any suitable expedient, such as controls for independent motors or servo drives.

For illustration, a transport lug such as lug 18 is shown in FIG. 9. Lugs 16, 18 are releasably mounted to a carriage on their respective chains such as by a slot 32 and snap on latch 33, which cooperate with a chain attached carrier 20a shown in FIG. 9. Lugs 16, 18, are identical. Each includes a lug body 34 having an upstanding lug (16, 18) and a curved upper surface 35, defined in part by a carton engaging and carry surface 35a. Surface 35a supports the leading underside of a transported carton just above chains 20, 22.

It will also be appreciated that platforms 23 are carried by chains 20, 22 and define an upper surface for engaging and transporting trailing ends of cartons thereon. Thus the cartons are carried by the chains 20, 22 and transport lug structures and not on stationary guides, rails or slides above the chains.

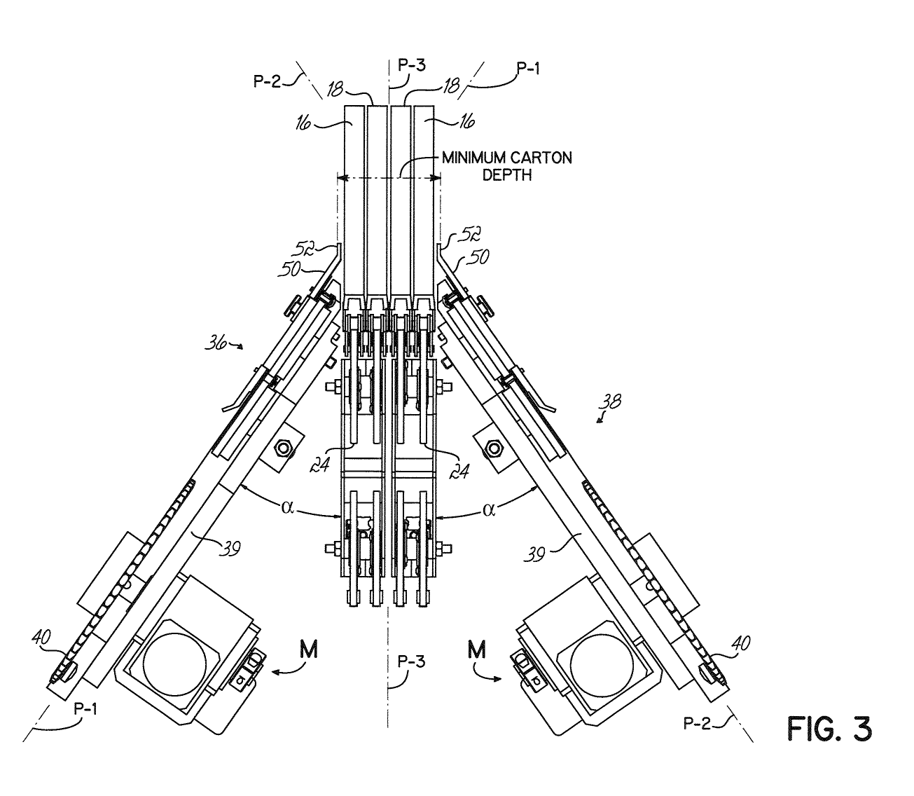

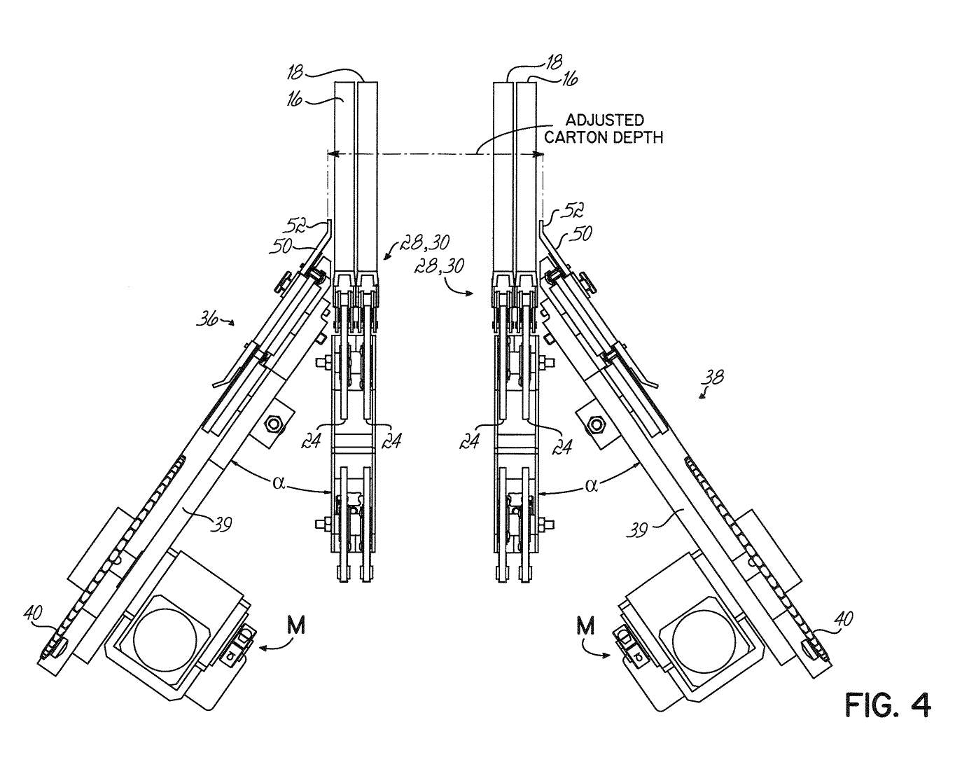

Blank feeder section 14 includes two feed dog drives 36, 38 (FIGS. 3 and 4). As illustrated in FIGS. 3, 4, the components of the respective feed dog drives 36, 38 lie in or are oriented in, a plane which is inclined to the vertical at an angle “a”. The inclination or angle “a” of 35 degrees is illustrated. Numerous angles of inclination may be used, such as 55 degrees or other angles suitable to the ends of the invention as described herein.

More particularly, each inclined feed dog drive preferably includes, without limitation, a mounting plate 39 for the drive components, a motor M and any necessary reducer for driving, a drive gear 40, idler gears 42, 44, a discharge end idle gear 46, a chain or flexible member 48 and a plurality of pusher dogs (carton feed dogs) 50 pivoted to chain 48. Preferably the axes of these respective sprockets are disposed at an angle to the horizontal to in part define the angled or inclined feed dog drive.

Pusher or feed dogs 50 have a body portion lying in the inclined plane of these feed dog drive components, and a vertically oriented tip 52 as shown. Such tips 52 lie in planes which are respectively parallel to the generally vertical planes defined by transport lugs 16, 18. In operation, the feed or pusher dogs 50 are preferably driven at a linear velocity greater than that of the leading lugs against which the blank is pushed, in order to push blanks against the lead lug or at least partially erect into cartons the fed flat blanks.

With the inclination of the respective drives 36, 38 at an angle inclined to the vertical and as illustrated, and with the inclined feed dogs 50 with vertically extended tips 52, it will be appreciated that the feed dogs 50 can be very closely disposed to the outer transport lugs 16 as illustrated in FIG. 3. In contrast, were the feed dog drives 36, 38 oriented in a primary vertical plane, with straight upstanding feed dogs, there would be insufficient width across the cartoner to accommodate both the transport drive mechanism and the feed dog drive mechanism for short depth cartons. The width of the drive mechanism for the feed dogs would thus interfere with the respective drives for the transport lugs 16, 18. This expected interference would result in a feed dog drive spacing with a disposition of the feed dogs well outside of the desired minimum carton depth orientation illustrated in FIG. 3. This would limit the smaller carton depths (i.e. the dimension of the carton measured transverse to the flow or machine direction MD which is perpendicular to FIG. 3) of cartons which could be fed, and then handled by cartoner 10.

It will be appreciated that one or both drives 36, 38 could be mounted on linear bearings 56, 58 of any suitable construction for relative movement toward and away from each other in a transverse direction relative to the machine direction (MD). One drive could be fixed and the opposite drive adjustable together with a cooperating width adjustment of the opposite transport tracks for the transport lug chains to accommodate larger carton depths. Such drives 36, 38 can be adjusted with the transversely adjustable tracks 28, 30 to accommodate larger cartons of greater transverse depth than the minimum illustrated in FIG. 3. Such a configuration is shown in FIG. 4 where the track pairs 28, 30 and drives 36, 38 are respectively adjusted further apart for handling such larger cartons.

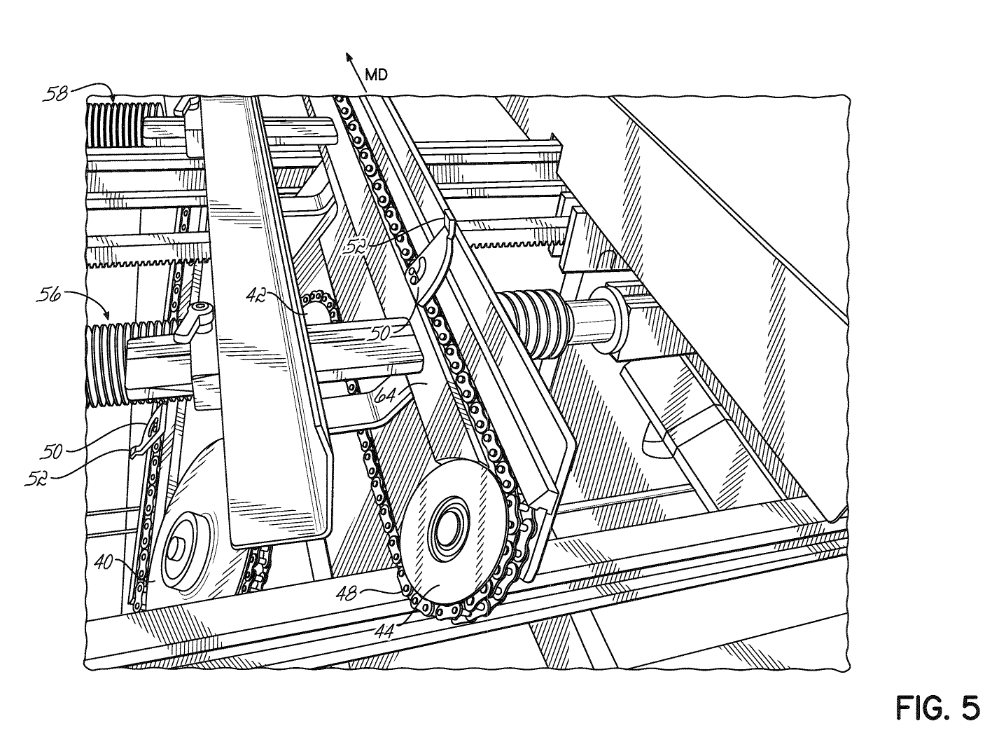

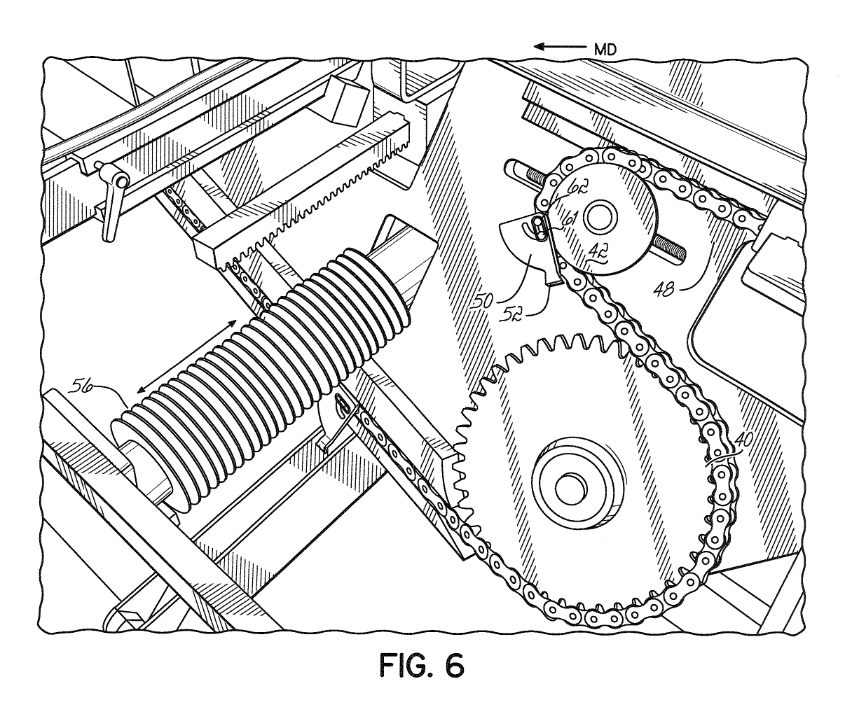

FIGS. 5-7 illustrate further details of one of the inclined feeder dog drives 36 of blank feeder 14. The opposite side feeder 38 is similar but with a mirror incline. Chain 48 is operatively disposed on inclined drive gear 40 and around inclined idler gears 42, 44 and 46.

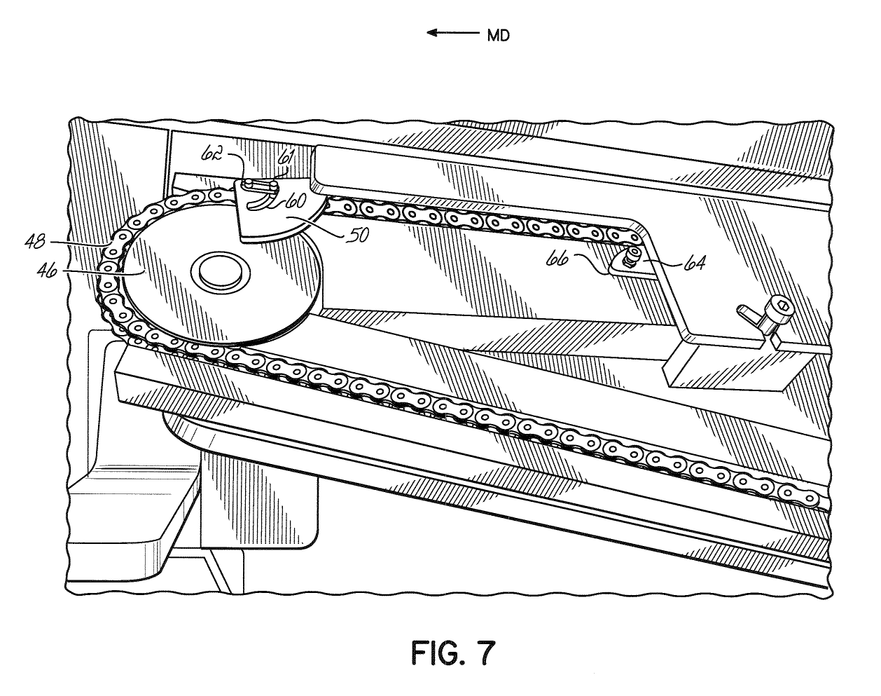

Pusher or feed lug or dog 50 is pivoted to chain 48 of each side's feeder drive 36, 38, perhaps as best seen in FIG. 7. An arcuate slot 60 in the dog captures a limit pin 61 which limits rotation of dog 50 on chain 48 about pivot mount pin 62. An elongated cam 64 (FIG. 7) extends along an upper run of chain 48 defined between pulleys or gears 44, 46. When the dogs 50 are pulled by chain 48 through this run, the cam 64 erects the dog 50 so tip 52 extends upwardly to engage the rear edge of a flat carton blank (not shown). When the dog 50 is pulled past end 66 of cam 64, the dog 50 is released for return travel toward drive gear 40 and pulleys 42, 44 and quickly pivots below any respective carton. At the same time, dog 50 is free to rotate by gravity out of any interference with the trailing carton blank edge as necessary.

It will be appreciated that the dogs 50 rotate by gravity and that the angle “a” of the dog drives facilitates the rotation by gravity. Since rotation of the dogs 50 by gravity is preferred, this is one of the considerations for selection of the degree of angular disposition of the drives 36, 38.

It will also be appreciated that the dogs 50 can be so mounted at a variety of positions on chains 48 as desired for a variety of positions on chains 48 as desired, for a variety of desired carton pitch, and for adjustment of the apparatus to different spacing or pitch.

The release end position of cam end 66 is oriented to release the dog 50 as trailing transport lugs 18 pick up the trailing edge of a blank and urge it toward lead lug 16, with such continued motion further erecting the blank between respective lugs 16, 18 if desired. The release of dogs 50 by cam end 66 can be timed or coordinated as desired with the phase of the trailing lugs 18 as desired.

Accordingly, cartons of very short depth such as at four inches, can be advantageously fed, erected and transported according to the invention. Blank feeding of very shallow depth blanks is accomplished without interference of the blank feeder drives as when traditionally formed.

Reference to FIG. 3 further serves to clarify the invention. In that FIG. 3, it will be appreciated that inclined feed dog drive 36 generally resides in a first plane represented by a line P-1 in that plane. Feed dog drive 38 resides in another plane represented by a line P-2 in that second plane. The transport lugs and transport lug drives generally reside in a substantially vertical other plane represented by a line P-3 in that other vertical plane.

The actual planes, of course, are thicker than the noted lines in each plane but the lines P-1, P-2 and P-3 are used in FIG. 3 to illustrate the general inclination of the planes and respective drives therein.

Accordingly, components of drives 36, 38 are respectively disposed at an angle to the transport lugs or transport drives shown, presenting the feed dogs 50 to operational runs thereof while accommodating very short depth cartons, otherwise not possible due to structural interferences if all the drives were vertically oriented transversely.

It will be appreciated that all components of the feed dog drives 36, 38 may not be mounted at an incline and some components might be designed to be vertically oriented but with lateral extension of the feed dogs 50 and an operative run of their chains disposed closely adjacent the transport lug drives. Accordingly, it is contemplated that in accord with the invention, at least the flexible component, i.e. chain or belt, is in an inclined plane represented by lines P-1 or P-2.

In operation, a flat carton blank is fed into a position (by any available blank feeder or placing mechanism) where its rear edge is engaged by feeder dogs 50. These dogs move at a velocity greater than that of leading lugs 16 so as the blank is pushed in the machine direction by dogs 50, the blank engages the rear of lugs 16. Continued diminishing space between the advancing lugs 16 and the faster moving feeder dogs 50 erects the carton into its final or near final three-dimensional shape. At this time, the trailing lugs 18 have moved about the entry end sprockets carrying chains 20, 22 and advance toward an essentially vertical position behind the now essentially erected carton. Just before lugs 18 reach a vertical position, dogs 50 are released by cam 64 allowing their tips 52 to fall away from the carton without driving through and damaging them.

The trailing lugs 18 reach vertical at a position or location along the machine direction MD referred to as the “constant opening line”. Such a location remains consistent for any carton size and pitch. Accordingly, the dogs 50 are timed to be released by cam 64 (and 66 in FIG. 9) just prior to their final movement to the constant opening line position.

Once the trailing lugs 18 reach the constant opening line, the cartons are, if not before, fully erected and are then transported forwardly for other operation and manipulation such as filling, flap manipulation, sealing and the like as desired.

For purposes of this application, the term “drive” as used herein refers to components of the mechanisms for moving or driving the transport lugs and feeder dogs, respectively, such that reference to the vertical or angular disposition of the respective transport lug drive or feeder dog drive refers to at least some components of the respective drive.

In the preferred embodiment, these respective components in each drive include the respective chains in their respective operational and return runs or paths. The components may or may not include the sprockets supporting such chains or the motors.

It will also be appreciated that the respective axes of the sprockets for the transport lug chains are preferably horizontally disposed, while the axes for the sprockets of the feed dog chains are disposed at an inclined angle to the horizontal, such as 55 degrees.

Thus, for descriptive purposes herein, it will be appreciated that the drives for the transport lugs and the feed dog lugs are preferably flexible drives incorporating chains as described. Alternately, the drives could be flexible belt drives having appropriate accessories for lug and dog connection.

In any event, it will be appreciated that the flexible chains or belts for the respective transport lugs of the respective transport drives have operational and return runs, each lying in a substantially vertical common plane. It will also be appreciated that the flexible chain or belt drive for each feeder dog has an operational and a return run lying in a common plane disposed at an angle to the plane of the transport lug drive.

Finally, it will be appreciated that any suitable apparatus (not shown) may be used for placing or introducing flat carton blanks to the blank feed and erecting section 14 for further handling by the feed dogs 50 and transport lugs 16, 18.

These and other modifications and variations of the invention will be readily appreciated by the foregoing to those of ordinary skill in the art without departing from the scope of the invention and applicant intends to be bound only by the claims appended hereto.

What is claimed is:

1. In a cartoner having carton transport lugs driven by a transport lug drive disposed in one plane; a blank feeder comprising blank feeder dogs driven by at least one feeder dog drive disposed in another plane,
wherein said feeder dog drive in another plane is disposed at an angle to said plane of said transport lug drive.

2. A cartoner as in claim 1 including two feeder dog drives, each oriented in a respective plane at an angle to said transport lug drive.

3. A cartoner as in claim 1 wherein feeder dogs are pivoted to a feeder dog drive chain of said feeder dog drive and further including a cam is oriented to erect and to release said feeder dogs into and out of operative position with respect to a carton blank.

4. A cartoner as in claim 1 wherein said feeder dogs include a feed dog body and a carton engaging tip disposed at an angle to said body.

5. A cartoner as in claim 1 further including carton carrying platforms carried on chains driving said transport lugs, each transport lug comprising a body and a lug extending from said body, said body having a curved upper surface a portion of which defines a carton engaging and carrying surface.

6. A cartoner as in claim 5 further including platforms mounted on said chains driving said transport lugs, said platforms having upper carton engaging and carrying surfaces.

7. Apparatus for cartoning including:
a carton transport conveyor having leading and trailing transport lugs and respective transport lug drives for driving said lugs respectively;
said transport lugs disposed and operating in a vertical plane;
a carton feeder including feed dogs for driving cartons onto said transport conveyor;
feed dog drive apparatus having at least a feed dog drive component disposed and operating in another plane oriented at an angle to said vertical plane for moving said feed dogs through an operative run and a return run.

8. Apparatus as in claim 7 wherein said feed dog drive component is a flexible member.

9. Apparatus as in claim 8 wherein said flexible member is a chain.

10. Apparatus as in claim 8 wherein said feed dogs are pivoted to said flexible member.

11. Apparatus as in claim 10 further including a cam oriented to erect said feed dogs into a carton engaging position in said operative run and to release said feed dogs from said carton engaging position for movement in a return run.

12. Apparatus as in claim 11 wherein said cam has a release end for releasing respective feed dogs from a carton engaging position at approximately the same time as a trailing lug engages a carton moved by said releasing feed dog.

13. Apparatus as in claim 7 wherein said transport conveyor has two lead and two trailing transport lugs defining a pocket for cartons fed thereto, one lead lug, and one trailing lug disposed transversely for engaging on each respective end of a carton;
said lead and trailing lug disposed for engaging on one end of a carton being adjustably spaced from corresponding lead and trailing lugs for engaging another end of a carton;
a feed dog disposed for engaging on each respective end of said carton;
respective feed dog drives for each said feed dog; and
said feed dog drives being adjustably spaced apart with a respective adjacent lead and trailing lug.

14. A carton feeding and transporting apparatus comprising carton transporting lugs and lug drive oriented in a vertical plane;
carton blank feed dog apparatus for driving cartons toward said transporting lugs; and
a feed dog drive oriented in a plane disposed at an angle to said vertical plane.

15. A method of feeding flat carton blanks to a cartoner wherein said blanks have been erected into cartons, said method comprising the steps of:
feeding flat carton blanks to a carton blank feed dog conveyor comprising dogs for engaging said blanks and feeding them toward leading carton transport lugs of said cartoner;
moving said transport lugs in a vertical plane for receiving cartons; and
driving said feed dogs with a feed dog drive apparatus oriented in a plane at an angle to said vertical plane.
